(19) United States
(12) Patent Application Publication
(10) Pub. No.: US 2023/0168420 A1
(43) Pub. Date: Jun. 1, 2023

(54) FUNCTIONAL POLARIZING ELEMENT FOR INSERT MOLDING AND FUNCTIONAL POLARIZING LENS

(71) Applicant: TALEX CO., LTD., Osaka (JP)

(72) Inventors: Hiroo TAMURA, Osaka (JP); Kenzo WADA, Osaka (JP)

(21) Appl. No.: 17/922,887

(22) PCT Filed: Apr. 5, 2021
(86) PCT No.: PCT/JP2021/014491

§ 371 Date: Nov. 2, 2022

(30) Foreign Application Priority Data
May 22, 2020 (JP) 2020-089356

(51) Int. Cl. G02B 5/30; G02B 1/14; G02B 27/28

(52) U.S. Cl. CPC G02B 5/3025; G02B 1/14; G02B 27/28

(57) ABSTRACT

A functional polarizing element for insert molding is provided which is constituted by a polarizing film; a cured coating film formed on a concave surface of the polarizing film by applying and drying a coating material containing 100 parts by mass of a transparent adhesive and 4 to 20 parts by mass of a functional dye; and a cured coating film of a transparent adhesive, and coating a convex surface of the polarizing film. Also, a functional polarizing lens is provided which is obtained by insert molding using the functional polarizing element.

### TECHNICAL FIELD

The present invention relates to a functional polarizing element for insert molding used to produce an optical lens for, e.g., polarizing spectacles, and a functional polarizing lens using the polarizing element.

### BACKGROUND ART

Polarizing lenses generally have a polarizing film attached to the surface of the lens or inserted in a layered structure of the lens, and are widely used as spectacle lenses or other optical components.

For example, it is known that, as a polarizing film, a polarizing element is used which comprises a uniaxially stretched PVA film impregnated with an iodine-based compound or a dichroic dye; and protective films laminated on both surfaces of the PVA film, the polarizing element is laminated on the surface of a lens, and coating such as hard coating is applied to the surface of the polarizing element (below-identified Patent Document 1).

Also, it is known that, for a polarizing optical element including a lens substrate (basic transparent optical element), and a layered structure provided with a polarizing film, at least one pressure-sensitive adhesive layer is attached to the layered structure, and a tackifier, a softener, a bonding agent, an antioxidant, a stabilizer, a pigment, a dye, a dispersant and a diffusing agent can be added to the pressure-sensitive adhesive (below-identified Patent Document 2).

Also, it is known that (i) lens substrate layers each containing a predetermined resin as its main component are integrally formed, by insert molding, on both surfaces of a polarizing film on its front and rear sides, (ii) a polarizing element including a polarizing film of which both surfaces are coated with a resin containing an infrared absorbing agent, and a spectacle lens substrate that can be ground to adjust lens power are integrally formed by insert molding, thereby producing a lens for polarizing spectacles, and (iii) the lamination and integral formation cannot be performed reliably (below-identified Patent Document 3).

### PRIOR ART DOCUMENT(S)

### Patent Document(s)

Patent Document 1: Japanese Unexamined Patent Application Publication No. H09-258009
Patent Document 2: Japanese Unexamined Patent Application Publication No. 2012-252362 (paragraph [0021])
Patent Document 3: Japanese Patent No. 6553157 (claim 1, paragraph [0010])

### SUMMARY OF THE INVENTION

### Problems to Be Solved by the Invention

However, for a layered structure as disclosed in Patent Document 2, if a polarizing element is bonded to the surface of a lens substrate via a pressure-sensitive adhesive, the pressure-sensitive adhesive is likely to deteriorate due to, e.g., ultraviolet rays and separate. Also, since the larger the amount of additives, the lower the adhesiveness of the pressure-sensitive adhesive, the amount of dye or pigment added needs to be made as small as possible. Therefore, it is difficult to add a sufficient amount of dye or pigment to obtain an expected function.

Especially in order to produce a functional polarizing lens having a plurality of specific wavelength absorption ranges, it is required to add up a plurality of kinds of functional dyes, and add them in a large amount. However, it is difficult to obtain a functional polarizing lens containing a large amount of such functional dyes, and moreover having a layered structure that does not separate.

Also, since a pressure-sensitive adhesive needs to be bonded (adhered), in a non-dry state or an adhesive state, to a lens substrate, when, as disclosed in Patent Document 3, forming a polarizing element by insert molding and producing a lens for polarizing spectacles, an adhesive is not used as a resin layer coating the surface of the polarizing element.

Due to such reasons, in order to provide composite functionality to a polarizing lens, functional dyes are added to not an adhesive layer but a lens substrate. However, in order to add various functional dyes to a lens substrate, since cleaning or replacement of a resin tank for forming a resin substrate is required in the producing step, and this is complicated work, the production efficiency of functional polarizing lenses or the yield rate of such products tends to decrease, so that elimination of these factors and improvement are required.

It is an object of the present invention to provide a functional polarizing element for insert molding and a functional polarizing lens which can solve the above problems, i.e., which have the following advantages: deterioration of a functional dye is reduced; a resin layer containing the functional dye is reliably retained by the lens without separating while the lens is in use; and the production efficiency and the yield rate of components constituting the lens can be improved.

### Means for Solving the Problems

In order to achieve the above object, the present invention provides a functional polarizing element for insert molding comprising: a polarizing film; and a cured coating film containing 100 parts by mass of a transparent adhesive and 4 to 20 parts by mass of a functional dye, the cured coating film coating one or each of both surfaces of the polarizing film.

In the functional polarizing element for insert molding according to the present invention, since a cured coating film containing a transparent adhesive as its main component is retained integrally with a polarizing film with a predetermined amount of functional dye for providing a function dispersed in the adhesive, the heat from around the polarizing element is less likely to be transmitted to the functional dye through the adhesive, thus making it possible to reduce deterioration of the functional dye due to heat during insert molding.

Also, since the polarizing element formed inside of lens substrates by insert molding is retained with the functional dye trapped in the adhesive, the functional dye is not exposed to outside air, and its deterioration due to, e.g., oxidation is also prevented. Also, since deterioration, due to, e.g., ultraviolet rays, of the adhesive forming the cured coating film is similarly prevented, the adhesive strength is maintained, and durability such as weather resistance is improved, so that the functional polarizing element is less likely to separate from the lens substrates.

Also, for a polarizing lens using such a functional polarizing element for insert molding, it is not required to separately form a functional layer by, e.g., coating after molding, and required functionality is provided concurrently with insert molding. Therefore, this polarizing lens can be efficiently produced.

As the transparent adhesive having good adhesiveness relative to lens substrates made of a synthetic resin, one of a urethane resin-based adhesive, an acrylic resin-based adhesive and an epoxy resin-based adhesive is preferably used.

As the functional dye retainable, in the above predetermined amount, in such an adhesive, one of an infrared absorbing dye, an ultraviolet absorbing dye, a specific wavelength range absorbing dye and a photochromic dye is preferably used.

If, as the above specific wavelength range absorbing dye, a specific wavelength range absorbing dye is used which absorbs one or more of the wavelength range of 450 to 500 nm, the wavelength range of 570 to 610 nm, the infrared wavelength range of 780 nm or more, it is possible to obtain a functional polarizing element for insert molding which is excellent in blue-light-blocking properties, ultraviolet absorbency, high contrast properties and infrared absorbency.

The cured coating film preferably has a thickness of 0.01 to 0.2 mm such that the functional dye is uniformly/evenly contained in the coating film layer, and has a uniform function.

By insert molding using such a functional polarizing element for insert molding, it is possible to obtain a functional polarizing lens in which a resin layer containing a functional dye is trapped, and a lens substrate (or substrates) made of a resin is integrally superposed on the resin layer.

### Effects of the Invention

Since the functional polarizing element for insert molding of the present invention includes a polarizing film coated with a coating material containing, as its main component, a transparent adhesive containing 4 to 20 parts by mass of a functional dye, the functional polarizing element is advantageous in that a resin layer containing the functional dye is less likely to separate and deterioration of the functional dye is prevented.

The functional polarizing lens obtained by insert molding using this polarizing element also has the above advantage, and is improved in production efficiency and excellent in productivity.

### BRIEF DESCRIPTION OF THE DRAWINGS

FIG. 1 is a sectional view of a functional polarizing element for insert molding according to a first embodiment of the present invention.

FIG. 2 is a sectional view of a functional polarizing element for insert molding according to a second embodiment of the present invention.

FIG. 3 is a sectional view of a functional polarizing lens formed by insert molding with the functional polarizing element of the first embodiment retained by gaskets and molds.

FIG. 4 is a graph showing the spectral transmittances of the lenses of Example 5 and Comparative Example 2 measured by a spectrophotometer.

### BEST MODE FOR CARRYING OUT THE INVENTION

Embodiments of the present invention are described below with reference to the drawings.

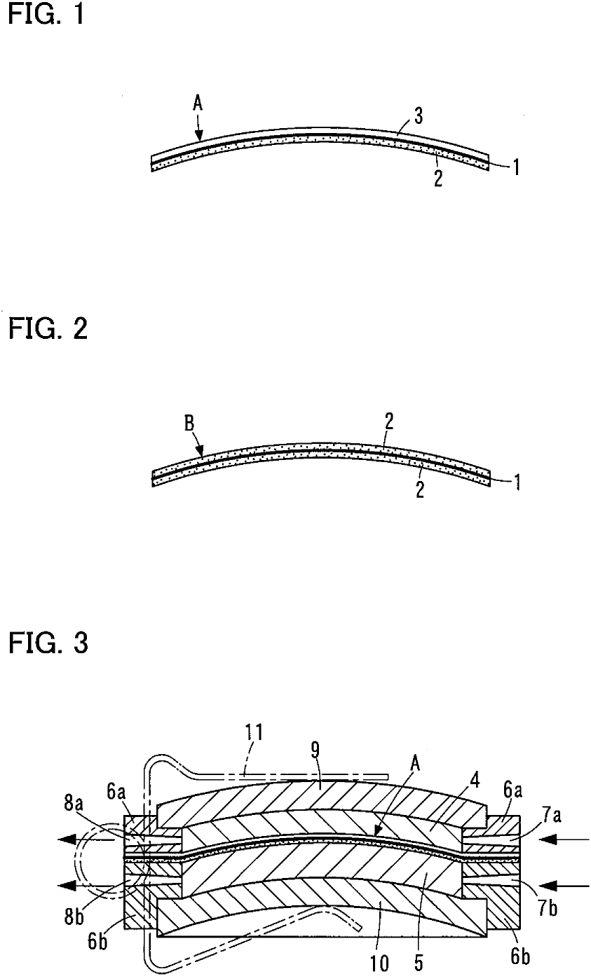

FIG. 1 illustrates a functional polarizing element A for insert molding according to the first embodiment which is constituted by a polarizing film 1 composed of a polyvinyl alcohol (PVA) film formed into a bowl shape by pressing; a cured coating film 2 formed on the concave surface of the polarizing film 1 by applying and drying a coating material comprising 100 parts by mass of a transparent adhesive and 4 to 20 parts by mass of at least one functional dye; and a cured coating film 3 of a transparent adhesive, and coating the convex surface of the polarizing film 1.

FIG. 2 illustrates a functional polarizing element B for insert molding according to the second embodiment which differs from the first embodiment in that, after forming the cured coating film 2 on the concave surface of the bowl-shaped polarizing film 1, a cured coating film 2 similarly containing a functional dye is formed on the convex surface of the polarizing film 1, too.

The polarizing film is formed by stretching a thin film made of, e.g., polyvinyl alcohol (PVA) to about three to five times its original size, and making it adsorb a dichroic colorant comprising iodine or a dichroic dye to orient the crystal structure or the molecules.

The material of the polarizing film 1 is not limited to PVA. For example, the polarizing film 1 may be a composite film obtained by bonding a film made of, e.g., triacetyl cellulose or polycarbonate to a film made of polyethylene terephthalate (PET) or PVA.

After the uniaxially stretched polarizing film 1 of, e.g., PVA is cut into a quadrangular shape according to the size of a lens of the meniscus type, the surfaces of the polarizing film are shaped into spherical curved surfaces along the curve (radius of curvature) of the lens by a known, pressure applying and shaping means (by pressing), and further the polarizing film is coated with the cured coating film(s) 2, and used for insert molding.

The above transparent adhesive may be, for example, (i) an adhesive containing, as its main component, a transparent resin bondable to the polarizing film and the resin of lens substrates used for insert molding, and preferably having properties to become an elastic element like rubber after curing, or (ii) an adhesive containing, as its main component, a transparent solvent bondable to the resin of the above lens substrates.

The above bondable transparent resin has wettability relative to the polarizing film such that a soft or semihard resin coating film having non-adhesiveness and elasticity is formed while having a uniform film thickness, and while cured on the surface of the polarizing film.

The above transparent adhesive is preferably a transparent elastic adhesive such as a urethane resin-based adhesive, an acrylic resin-based adhesive or an epoxy resin-based adhesive. The above elastic adhesive refers to an adhesive having properties to become an elastic element like rubber after curing.

As the urethane resin-based elastic adhesive, a polyurethane-based adhesive of the two-liquid reaction type or the reactive hot melt type comprising a main agent and a curing agent can be used. As commercially available products of these adhesives, there are, e.g., trade name VP9446/10, which is a PUR adhesive of the two-liquid reaction type made by Kleiberit Japan, and trade name VP9484/10, which is an adhesive of the reactive hot melt type made by the above company.

The acrylic resin-based elastic adhesive is a soft or semihard adhesive containing, as its main component, a solvent relative to the acrylic resin of the lens substrates. The solvent as the main component may contain dichloromethane and/or dichloroethane. Also, ethyl alcohol or glacial acetic acid may be added to the solvent as an adjustment component for retarding the curing speed.

Examples of the epoxy resin elastic adhesive include, e.g., commercially available Konishi bond E70, which is a transparent and solvent-free epoxy resin-based adhesive of the reaction type containing an epoxy resin as a main agent and a modified alicyclic polyamine as a curing agent.

Examples of the functional dye used in the present invention include an infrared absorbing dye, an ultraviolet absorbing dye, a specific wavelength range absorbing dye and a photochromic dye, and the functional dye also may be, e.g., a thermochromic light absorbing agent.

As the ultraviolet absorbing agent/dye, a known ultraviolet absorbing agent is usable which has absorbency with respect to ultraviolet wavelengths (100 nm to 380 nm). Representative examples thereof include the following chemical compounds:
(1) 2-hydroxy-4-n-octoxybenzophenone;
(2) 4-dodecyloxy-2-hydroxybenzophenone; and
(3) 2-2′-hydroxy-4-methoxybenzophenone.

These ultraviolet absorbing agents used preferably absorb all of the ultraviolet rays of UV-A (315 to 400 nm), which has a long wavelength, UV-B (280 to 315 nm), which has a short wavelength, and UV-C (100 to 280 nm), which is shorter in wavelength than UV-B.

As the infrared absorbing agent/dye, a known infrared absorbing agent is usable which has absorbency with respect to infrared wavelengths (780 nm to 2,500 nm). Examples thereof include, e.g., the following chemical compounds:
(1) an infrared absorbing agent comprising an N,N,N′,N′-tetrakis (p-substituted phenyl)-p-phenylenediamine, a benzidine, and their aluminum salts or diimonium salts;
(2) an N,N,N′,N′-Tetraarylquinonediimonium salt; and
(3) bis-(p-dialkylaminophenyl) [N,N-Bis (p-dialkylaminophenyl) p-aminophenyl] aminium salts.

Examples of the specific wavelength range absorbing dye include, e.g., a tetraazaporphyrin compound which absorbs light having a wavelength within a specific visible light range of or close to 580 to 585 nm to provide high contrast properties. As a commercially available product thereof, for example, TAP-2 or TAP-9 made by Yamada Chemical Co., Ltd. may be used.

The photochromic dye is also known as a photochromic compound, and examples thereof include, e.g., a known spirooxazine compound and a known tetra (or hexa) benzopropylene-based compound.

Since spirooxazine-based compounds tend to be weakened in weather resistance by ultraviolet rays of short wavelengths, in order to improve weather resistance, a particulate spirooxazine-based compound of which the individual particulates are wrapped with a light shielding inorganic film and dispersed in the resin matrix may be used.

The thermochromic light absorbing agent is a chemical compound whose light absorbency changes depending on temperature. Examples of the thermochromic compound having such properties include a leuco dye and a thermochromic liquid crystal.

Specific examples of the thermochromic liquid crystal include nonane acid cholesteryl and cyanobiphenyl. Specific examples of the leuco dye include spirolactone, fluoran, spiropyran, fulgide, and their combination. The liquid crystal and the leuco dye may be microencapsulated and mixed in a polymerizable mixture.

The amount of the at least one functional coating material (functional dye) added such as the above infrared absorbing dye, ultraviolet absorbing dye, specific wavelength range absorbing dye, photochromic dye or thermochromic light absorbing agent is preferably 4 to 20 parts by mass, more preferably 4.5 to 20 parts by mass, and still more preferably 5 to 20 parts by mass, relative to 100 parts by mass of the above transparent adhesive, to sufficiently provide an expected function.

As the material of the lens substrates, it is possible to widely use any resin which can form a spectacle lens by cast molding. Representative examples thereof include, e.g., a methyl methacrylate resin (MMA) and a polycarbonate resin (PC), which are excellent in transparency as thermoplastic resins, allyl diglycol carbonate (CR-39), which is a representative thermosetting resin of the cast type, a medium refractive index resin containing similar components (e.g., Corporex made by Nippon Oil & Fats Co., Ltd, refractive index 1.56), and a thiourethane resin, which is a known high refractive index resin obtained by combining isocyanate and polythiol together (e.g., thiourethane-based resin MR-7 made by Mitsui Chemicals, refractive index 1.67).

As illustrated in FIG. 3, insert molding for forming the functional polarizing lens of the present invention is a molding means by which the polarizing element A can be embedded between two lens substrates 4 and 5 on the front and back sides. Specifically, cast molding is performed in the state in which (i) the end surfaces of two cylindrical gaskets 6a and 6b made of a flexible soft resin such as silicone resin are opposed to each other and superposed on each other, and (ii) the peripheral edge portion of the disk-shaped polarizing element A, curved in a spherical shape along the curve (radius of curvature) of the lens, is sandwiched between and engaged with the above opposed end surfaces.

The cylindrical gaskets 6a and 6b include resin injection holes 7a and 7b extending through the tubular wall surfaces of the respective gaskets, and open to both sides of the polarizing element A. The gaskets 6a and 6b further include overflow holes 8a and 8b extending through the wall surfaces of the respective gaskets, and diametrically opposed to the resin injection holes 7a and 7b.

A pair of molds 9 and 10 are disposed between which a convex surface forming the front surface of the lens substrate 4 is opposed to a concave surface forming the back surface of the lens substrate 5, and the molds 9 and 10 are retained with their peripheral edge portions liquid-tightly fitted to the respective gaskets 6a and 6b. The surfaces of the molds 9 and 10 axially opposed to each other inside of the cylindrical gaskets 6a and 6b are disposed such that proper spaces are defined between the polarizing element A inserted and these opposed surfaces. The above spaces are retained with the surfaces of the molds 9 and 10 (opposite from the above opposed surfaces) sandwiched by a retaining tool such as a spring clip 11.

Preferably, the resin injection holes 7a and 7b are disposed on the lower side and a vertically elongated cavity is defined between the opposed surfaces of the two molds, because, with this arrangement, air can be released easily during resin injection, and insert molding can be performed such that air bubbles are not mixed into the injected resin material.

After the cavity is completely filled with a resin material, by performing heat curing to polymerize and cure the resin material, it is possible to form, by insert molding, a polarizing lens having composite functionality, i.e., having both of a specific light absorbing function and a polarizing function.

### EXAMPLE(S)

### Example 1

In order to provide absorbency in a specific wavelength range to the concave surface side of a polarizing film formed by pressing a polyvinyl alcohol (PVA) film into a bowl shape, a coating material was prepared by dissolving 8 parts by mass of a functional dye for high contrast (TAP9 made by Yamada Chemical Co., Ltd.) into 100 parts by mass of a polyurethane-based transparent elastic adhesive of the two-liquid reaction type (VP9446/10 made by Kleiberit Japan), the concave surface was spray-coated with the coating material, and the coating material was dried to form a cured coating film having a thickness of 20 µm on the concave surface.

After forming the cured coating film having non-adhesiveness and elasticity on the concave surface of the polarizing film, by coating its convex surface, in the same manner as described above, with only the above-described polyurethane-based transparent elastic adhesive, a cured coating film having a thickness of 20 µm was formed thereon. In this way, a functional polarizing element for insert molding was produced in which both surfaces of the polarizing film are coated with cured coating films made of an elastic adhesive and having a thickness of 20 µm, and which has high contrast properties.

### Example 2

In order to provide photochromic functionality to a polarizing film formed by pressing a polyvinyl alcohol (PVA) film into a bowl shape, a coating material was prepared by dissolving 20 parts by mass of a spirooxazine-based photochromic compound (PSP-33 made by Yamada Chemical Co., Ltd.) into 100 parts by mass of a polyurethane-based transparent elastic adhesive of the two-liquid reaction type (VP9446/10 made by Kleiberit Japan), both surfaces of the polarizing film were dip-coated with the coating material, and the coating material was dried and cured to form cured coating films having a thickness of 100 µm thereon. In this way, a functional polarizing element for insert molding was produced in which both surfaces of the polarizing film are coated with cured coating films having photochromic functionality, and having non-adhesiveness and elasticity.

### Example 3

In order to provide absorbency in specific three wavelength ranges to the concave surface side of a polarizing film formed by pressing a polyvinyl alcohol (PVA) film into a bowl shape, a dissolved coating material was prepared by dissolving into 100 parts by mass of an acryl-based transparent elastic adhesive containing dichloromethane as its main component (Sunbond made by Sanyo Kogyo Co., Ltd.):
(i) 4 parts by mass of a functional dye for high contrast (TAP9 made by Yamada Chemical Co., Ltd.),
(ii) 2 parts by mass of a blue-light-blocking dye in which the maximum absorption wavelength is 473 nm (FDB006 made by Yamada Chemical Co., Ltd.), and
(iii) 1.5 parts by mass of an infrared absorbing dye in which the maximum absorption wavelength is 754 nm (FDN001 made by Yamada Chemical Co., Ltd.),
the concave surface was spray-coated with the coating material, and the coating material was dried until a cured coating film having non-adhesiveness and elasticity, and having a thickness of 40 µm was formed thereon.

After, as described above, forming a cured coating film on the concave surface of the polarizing film, by, in the same manner as described above, coating its convex surface with only the above-described acryl-based transparent adhesive, and drying the adhesive, a functional polarizing element for insert molding was produced which has absorbency in three wavelength ranges, and in which both surfaces of the polarizing film are coated with cured coating films made of an adhesive, and having non-adhesiveness, elasticity, and a thickness of 40 µm.

### Example 4

In order to provide absorbency in specific two wavelength ranges to the concave surface side of a polarizing film formed by pressing a polyvinyl alcohol (PVA) film into a bowl shape, a coating material was prepared by dissolving into 100 parts by mass of an acryl-based transparent elastic adhesive containing dichloromethane as its main component (Sunbond made by Sanyo Kogyo Co., Ltd.):
(i) 6 parts by mass of a functional dye for high contrast (TAP9 made by Yamada Chemical Co., Ltd.); and
(ii) 3 parts by mass of a blue-light-blocking dye in which the maximum absorption wavelength is 473 nm (FDB006 made by Yamada Chemical Co., Ltd.),
the concave surface was spin-coated with the coating material, and the coating material was dried to form a cured coating film having non-adhesiveness and having a thickness of 30 µm.

After, as described above, forming the cured coating film on the concave surface of the polarizing film, by, in the same manner as described above, spin-coating its convex surface with only the above-described acryl-based transparent adhesive, and drying the adhesive, a functional polarizing element for insert molding was produced which has absorbency in two wavelength ranges, and in which both surfaces of the polarizing film are coated with cured coating films made of an elastic adhesive, and having a thickness of 30 pm.

### Comparative Example 1

Transparent lenses having various curves (curve 1, curve 2, curve 4, curve 6, curve 8, etc.) within the wall thickness range of 8 mm to 20 mm (e.g., transparent lenses having a wall thickness of 10 mm) were prepared using an allyl diglycol carbonate resin (CR39).

Next, using one of the transparent lenses instead of a glass mold (male or female mold) for inset molding, gaskets were attached to the transparent lens. Then, in the gaps of about 1 mm on both sides of a polarizing film (disposed between the two lenses and) obtained by pressing a polyvinyl alcohol (PVA) film into a bowl shape, a molding resin material was cast-molded which contains 8 parts by mass of a functional dye for high contrast (TAP9 made by Yamada Chemical Co., Ltd.) relative to 100 parts by mass of a CR 39 monomer.

Each lens assembly prepared by such two cast molding steps (also called the two-step polymerization) looked perfectly integrally laminated for a short time. However, since, after the lens assembly was left at normal temperature for a while, the convex surface layer and the concave surface layer were easily separated from the polarizing film, the lens assembly is not suitable for practical use.

### Examples 5 and 6

By insert molding using the functional polarizing elements for insert molding obtained in Examples 1 and 2, functional polarizing spectacle lenses (according to Examples 5 and 6) were produced.

That is, as illustrated in FIG. 3, the cavity between the opposed surfaces of the molds 9 and 10 is divided into two cavities by the functional polarizing element A fixedly sandwiched between the opposed end surfaces of the cylindrical gaskets 6a and 6b, and a polyurethane-based resin material (which comprises a prepolymer produced by reacting polyisocyanate with a polyhydroxy compound, and an aromatic polyamine (MOCA) added as a curing agent to the prepolymer) was injected, through the resin injection holes 7a and 7b, into the two cavities on both sides of the functional polarizing element A of Example 1 or B of Example 2. Next, the material was maintained at 40° C. for 3 hours, then gradually heated to 100° C., cured at 100° C. for 24 hours, and then cooled and taken out of the molds, thereby obtaining a functional polarizing spectacle lens.

### Comparative Example 2

A functional polarizing spectacle lens was prepared in the same manner as in Example 5 except that, instead of insert molding using the functional polarizing element obtained in Example 1, an iodine-based polarizing film was used which was formed by pressing, into a bowl shape, a polyvinyl alcohol (PVA) film on which iodine is adsorbed, and a functional dye for high contrast (TAP9 made by Yamada Chemical Co., Ltd.) was added, in the same amount as used in Example 1, to a polyurethane-based resin material used for insert molding.

### Examples 7 and 8

Using the functional polarizing element for insert molding obtained in each of Examples 3 and 4, insert molding was performed in the same manner as in Example 5, 6, thereby obtaining a functional polarizing spectacle lens.

Specifically, in each of Examples 5 and 6, instead of injecting a polyurethane-based resin material, an allyl diglycol carbonate resin (CR 39) was injected into the cavities on both sides of the functional polarizing element B of Example 3 or A of Example 4. Next, the resin was maintained at 30° C. for 7 hours, then gradually heated to 80 to 100° C., cured at 80 to 100° C. for 8 hours and cooled, and then taken out of the molds, thereby obtaining a functional polarizing spectacle lens.

For the functional polarizing spectacle lens obtained in each of Examples 5 to 8, since it is not necessary to add a functional dye to the lens substrates, cast molding is easy, and productivity is excellent. Also, since the resin layer(s) containing a functional dye is trapped by the lens substrate(s), the pressure-sensitive adhesive is less likely to deteriorate due to, e.g., ultraviolet rays, and the lens shows improved weather resistance and has a structure in which deterioration of the functional dye and separation between layers are prevented.

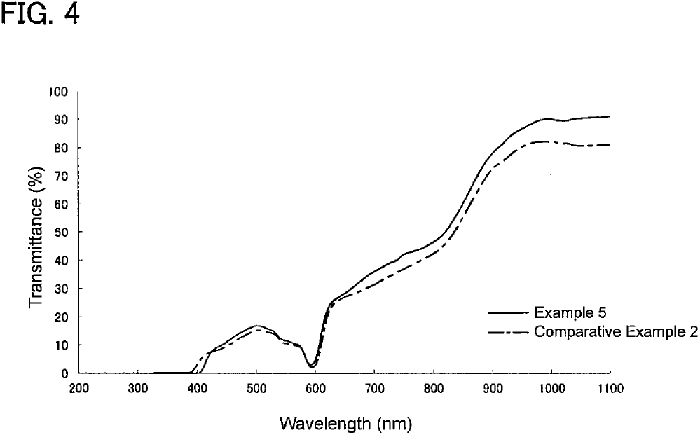

For the functional polarizing spectacle lens according to each of Example 5 and Comparative Example 2, the spectral transmittance was measured by a spectrophotometer (U-2000 spectrophotometer made by Hitachi, Ltd.), and the relationship between the wavelength within the range of 200 to 1100 nm and the transmittance is shown in FIG. 4.

As is apparent from the results shown in FIG. 4, for the functional polarizing spectacle lens of Example 5, since the maximum absorption wavelength close to 585 nm in the lens is shorter/smaller by about 5 nm than in the lens of Comparative Example 2, and the lens has a higher transmittance and a higher transparency than the lens of Comparative Example 2, deterioration of the functional dye during insert molding is reduced.

DESCRIPTION OF REFERENCE NUMERALS

| | |
|---|---|
| 1: | Polarizing film |
| 2, 3: | Cured coating film |
| 4, 5: | lens substrate |
| 6a, 6b: | Gasket |
| 7a, 7b: | Resin injection hole |
| 8a, 8b: | Overflow hole |
| 9, 10: | Mold |
| 11: | Spring clip |

1. A functional polarizing element for insert molding comprising:
a polarizing film; and
a cured coating film containing 100 parts by mass of a transparent adhesive and 4 to 20 parts by mass of a functional dye, the cured coating film coating one or each of both surfaces of the polarizing film.

2. The functional polarizing element according to claim 1, wherein the transparent adhesive is one of a urethane resin-based adhesive, an acrylic resin-based adhesive and an epoxy resin-based adhesive.

3. The functional polarizing element according to claim 1, wherein the functional dye is one of an infrared absorbing dye, an ultraviolet absorbing dye, a specific wavelength range absorbing dye and a photochromic dye.

4. The functional polarizing element according to claim 1, wherein the cured coating film has a thickness of 0.01 to 0.2 mm.

5. A functional polarizing lens comprising the functional polarizing element according to claim 1; and a lens substrate made of a resin and integrally superposed on the functional polarizing element.

6. The functional polarizing element according to claim 2, wherein the functional dye is one of an infrared absorbing dye, an ultraviolet absorbing dye, a specific wavelength range absorbing dye and a photochromic dye.

7. The functional polarizing element according to claim 2, wherein the cured coating film has a thickness of 0.01 to 0.2 mm.

8. The functional polarizing element according to claim 3, wherein the cured coating film has a thickness of 0.01 to 0.2 mm.

9. The functional polarizing element according to claim 6, wherein the cured coating film has a thickness of 0.01 to 0.2 mm.

10. A functional polarizing lens comprising the functional polarizing element according to claim 2; and a lens substrate made of a resin and integrally superposed on the functional polarizing element.

11. A functional polarizing lens comprising the functional polarizing element according to claim 3; and a lens substrate made of a resin and integrally superposed on the functional polarizing element.

12. A functional polarizing lens comprising the functional polarizing element according to claim 4; and a lens substrate made of a resin and integrally superposed on the functional polarizing element.

13. A functional polarizing lens comprising the functional polarizing element according to claim 6; and a lens substrate made of a resin and integrally superposed on the functional polarizing element.

14. A functional polarizing lens comprising the functional polarizing element according to claim 7; and a lens substrate made of a resin and integrally superposed on the functional polarizing element.

15. A functional polarizing lens comprising the functional polarizing element according to claim 8; and a lens substrate made of a resin and integrally superposed on the functional polarizing element.

16. A functional polarizing lens comprising the functional polarizing element according to claim 9; and a lens substrate made of a resin and integrally superposed on the functional polarizing element.
